(19) United States
(12) Patent Application Publication
(10) Pub. No.: US 2025/0044192 A1
(43) Pub. Date: Feb. 6, 2025

(54) METHOD AND DEVICE FOR ESTIMATING CAUSE OF BEARING FAILURE

(71) Applicant: OKUMA CORPORATION, Niwa-Gun (JP)

(72) Inventor: Takumi HONGO, Niwa-Gun (JP)

(73) Assignee: OKUMA CORPORATION, Niwa-Gun (JP)

(21) Appl. No.: 18/785,180

(22) Filed: Jul. 26, 2024

(30) Foreign Application Priority Data
Aug. 4, 2023 (JP) 2023-128055

(51) Int. Cl. G01M 13/045

(52) U.S. Cl. CPC G01M 13/045

(57) ABSTRACT

A method for estimating a cause of a bearing failure includes: calculating a magnitude of a vibration with respect to a frequency calculating a vibration mean value by removing an influence of the rotation speed and calculating a mean value of the magnitudes of the vibrations having a same ratio of the frequency with respect to a rotational frequency from a result of the frequency analysis at the plurality of rotation speeds obtained in the calculating of the magnitude; extracting a bearing-caused vibration value of a characteristic ratio frequency from the vibration mean values; determining whether or not the bearing is abnormal based on the bearing-caused vibration value; and estimating a failure occurrence cause based on a relation of the bearing-caused vibration values in the integer multiplied characteristic ratio frequencies at which the vibrations are caused by the bearing when the bearing is determined to be abnormal in the determining.

### CROSS REFERENCE TO RELATED APPLICATION

This application claims the benefit of Japanese Patent Application Number 2023-128055 filed on Aug. 4, 2023, the entirety of which is incorporated by reference.

### FIELD OF THE INVENTION

The disclosure relates to a method and a device for estimating a cause of a bearing failure based on the bearing failure detected with vibration data.

### BACKGROUND OF THE INVENTION

In a machine tool that performs a machining of a workpiece while rotating a tool or the workpiece mounted to a main spindle, a trouble, such as a deterioration of operation accuracy and an abnormal noise during the operation is likely to occur. The trouble is caused by a preload loss due to an abrasion of a bearing by an aged deterioration. In other case, the trouble is caused by a damage due to, for example, an entrance of foreign matter, poor lubrication. If above mentioned trouble occurs, a processing defect occurs to adversely affect production, for example, the shape and the machined surface of the workpiece become defective. When a malfunction, such as burn-out of a main spindle, occurs, the main spindle becomes unrotatable and the machine tool cannot be even operated in some cases.

When an abnormality, such as a damage in an inner race, occurs in a rolling bearing that supports a rotator, a vibration is caused. For a diagnosis of a bearing state using the vibration, a method using a vibration sensor has been known. JP 5146008 B discloses a method in which a vibration is measured to perform envelope processing and a frequency analysis, respective values of characteristic frequencies of an inner race, an outer race, and a rolling body calculated based on a predetermined relational expression are extracted, and a diagnosis is performed using thresholds mutually different between the inner race, the outer race, and the rolling body.

JP 6511573 B discloses a method in which vibrations are measured at a plurality of rotational frequencies, and a diagnosis is performed based on a mean value of magnitudes of the vibrations having the same ratio of the frequency with respect to the rotational frequency.

JP 6997054 B discloses a method for performing a diagnosis by classifying a state of a rolling bearing into a poor lubrication state and a bearing damaged state based on vibration data measured during a monitoring using a classifier that has learned a feature of vibration data of rolling bearings in which a normal grease and a grease having a different oil content ratio are sealed.

JP 5146008 B and JP 6511573 B enable fixing before a serious malfunction, such as burn-out of a bearing, which makes the main spindle unrotatable. Meanwhile, a diagnosis of a cause of the malfunction leading to the bearing failure is required for determination of a cost payer, such as insurance coverage of fixing, and for a measure for preventing recurrence.

Various causes are considered as the cause of the malfunction. For example, an overload due to collision, tool damage during cutting may be occurred. Further, contamination with foreign matter and poor lubrication due to poor management of a lubricating oil may be occurred. Accordingly, there are a wide variety of items to be checked. Especially, in the case of the failure in a machine relating to production, priority is given to restoring. Therefore, it is difficult to sufficiently perform investigation, and thus the cause of the malfunction cannot be investigated.

Further, the poor lubrication of grease described as a failure to be diagnosed in JP 6997054 B is one of the causes of the malfunction. On the other hand, if a case of a machine using oil air lubrification, a change of a bearing state due to poor lubrication rapidly transitions. Therefore, at a time when a diagnosis is performed, a bearing damage might have been occurred.

Accordingly, it is an object of the disclosure to provide a method and a device for estimating a cause of a bearing failure capable of performing a measurement for a diagnosis of a bearing state and estimating the cause of the failure leading to a change of the bearing state.

### SUMMARY OF THE INVENTION

To achieve the above-described object, a first configuration of the disclosure is a method for estimating a cause of a bearing failure when a failure occurs on a bearing that supports a rotator. The method includes: measuring a vibration when the rotator is rotated at a constant velocity at a plurality of rotation speeds; calculating a magnitude of the vibration with respect to a frequency from the vibration obtained in the measuring by a frequency analysis; calculating a vibration mean value by removing an influence of the rotation speed and calculating a mean value of the magnitudes of the vibrations having a same ratio of the frequency with respect to a rotational frequency from a result of the frequency analysis at the plurality of rotation speeds obtained in the calculating of the magnitude; extracting a bearing-caused vibration value of a characteristic ratio frequency from the vibration mean values, the characteristic ratio frequency being an integer multiplied ratio of the frequency at which the vibration is caused by the bearing with respect to the rotational frequency; determining whether or not the bearing is abnormal based on the bearing-caused vibration value; and estimating a failure occurrence cause based on a relation of the bearing-caused vibration values in the integer multiplied characteristic ratio frequencies at which the vibrations are caused by the bearing when the bearing is determined to be abnormal in the determining.

In another aspect of the first configuration, which is in the above-described configuration, in the estimating, for the bearing-caused vibration values in the integer multiplied characteristic ratio frequencies at which the vibrations are caused by the bearing: a failure cause is estimated as a poor lubrication when only the bearing-caused vibration value of one integer multiplied characteristic ratio frequency is large; and the failure cause is estimated as an overload or a contamination with foreign matter when it is not that only the bearing-caused vibration value of one integer multiplied characteristic ratio frequency is large.

To achieve the above-described object, a second configuration of the disclosure is a device that estimates a cause of a bearing failure when a failure occurs on a bearing that supports a rotator. the device includes a measuring unit, an analyzing unit, a vibration mean value calculating unit, a bearing-caused vibration value extracting unit, a failure determining unit, and a failure occurrence cause estimating unit that. The measuring unit measures a vibration when the rotator is rotated at a constant velocity at a plurality of rotation speeds. The analyzing unit calculates a magnitude of the vibration with respect to a frequency from the vibration obtained by the measuring unit by a frequency analysis. The vibration mean value calculating unit calculates a vibration mean value by removing an influence of the rotation speed and calculating a mean value of the magnitudes of the vibrations having a same ratio of the frequency with respect to a rotational frequency from a result of the frequency analysis at the plurality of rotation speeds obtained by the analyzing unit. The bearing-caused vibration value extracting unit extracts a bearing-caused vibration value of a characteristic ratio frequency from the vibration mean values. the characteristic ratio frequency is an integer multiplied ratio of the frequency at which the vibration is caused by the bearing with respect to the rotational frequency. The failure determining unit determines whether or not the bearing is abnormal based on the bearing-caused vibration value. The failure occurrence cause estimating unit estimates a failure occurrence cause based on a relation of the bearing-caused vibration values in the integer multiplied characteristic ratio frequencies at which the vibrations are caused by the bearing when the bearing is determined to be abnormal by the failure determining unit.

In another aspect of the second configuration, which is in the above-described configuration, in the failure occurrence cause estimating unit, for the bearing-caused vibration values in the integer multiplied characteristic ratio frequencies at which the vibrations are caused by the bearing, a failure cause is estimated as a poor lubrication when only the bearing-caused vibration value of one integer multiplied characteristic ratio frequency is large; and the failure cause is estimated as an overload or a contamination with foreign matter when it is not that only the bearing-caused vibration value of one integer multiplied characteristic ratio frequency is large.

The disclosure enables performing a measurement for a diagnosis of a bearing state and estimating a cause of a failure leading to a change of the bearing state.

### BRIEF DESCRIPTION OF THE DRAWINGS

FIG. 1 is a block diagram illustrating a configuration in which a device for estimating a cause of a bearing failure is applied to a main spindle of a machine tool.

FIG. 2 is a flowchart of a method for estimating the cause of the bearing failure.

FIG. 3 is a graph illustrating an example of a vibration waveform without an outstanding N-order component.

FIG. 4 is a graph illustrating an example of a vibration waveform with an outstanding N-order component.

### DETAILED DESCRIPTION OF THE INVENTION

The following describes embodiments of the disclosure based on the drawings.

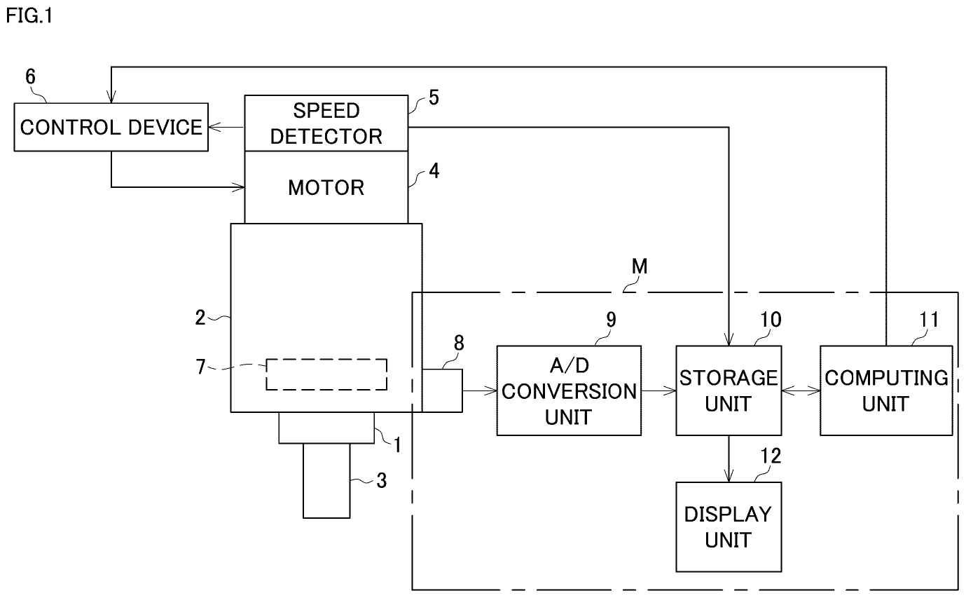

FIG. 1 is a block diagram illustrating a configuration in which a device for estimating a cause of a bearing failure according to a second configuration of the disclosure is applied to a main spindle of a machine tool.

A main spindle 1 is rotatably attached to a main spindle housing 2 via a bearing 7 as a rolling bearing, and a tool 3 for machining is secured to the main spindle 1. A motor 4 drives the main spindle 1. The motor 4 includes a speed detector 5, and a measured rotation speed of the motor 4 is input to a control device 6. The control device 6 controls a current supplied to the motor 4 so as to keep the rotation speed of the motor 4 measured by the speed detector 5 at a command rotation speed during the machining.

A vibration sensor 8 as a vibration measuring unit is attached to the main spindle housing 2, and the vibration sensor 8 measures a vibration acceleration at a plurality of rotation speeds (measuring step). The measured vibration acceleration is converted into a digital value by an A/D conversion unit 9, and stored in a storage unit 10 together with the rotation speed at the vibration measurement. The storage unit 10 stores also a predetermined threshold. A computing unit 11 includes a CPU and a memory, calculates a degree of failure of the bearing 7 from bearing specifications stored in the storage unit 10 and the rotation speed and the vibration acceleration stored in the storage unit 10 by the measurement, and determines whether or not the bearing 7 is normal. When the bearing 7 is determined to be not normal, the computing unit 11 estimates a cause of a change of the bearing state. A display unit 12 displays a diagnostic result by the computing unit 11.

A failure cause estimation device M of the disclosure includes the vibration sensor 8, the A/D conversion unit 9, the storage unit 10, the computing unit 11, and the display unit 12.

The vibration sensor 8 and the A/D conversion unit 9 constitute an example of a measurement unit of the disclosure.

The computing unit 11 is an example of an analyzing unit, a vibration mean value calculation unit, a failure determination unit, a bearing-caused vibration value extracting unit, and a failure occurrence cause estimation unit of the disclosure.

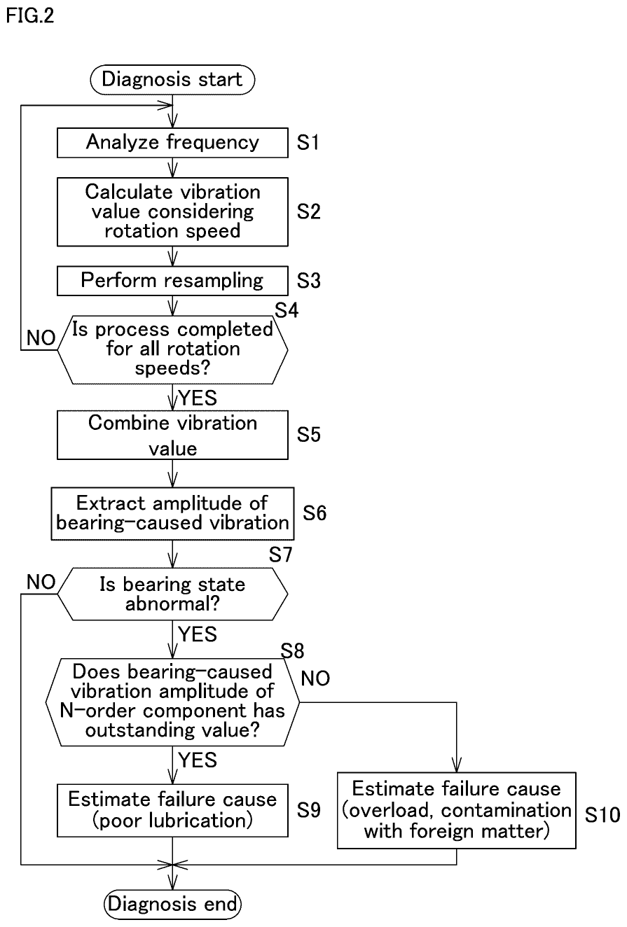

FIG. 2 is a flowchart of a method for estimating a cause of a bearing failure according to a first configuration of the disclosure illustrating processes of a failure diagnosis of a state of the bearing 7 and a failure cause estimation when a failure occurs in the bearing state performed by the computing unit 11. Details will be described below.

The computing unit 11 receives the rotation speed and the vibration acceleration at the vibration measurement from the storage unit 10, and starts a diagnosis of the bearing 7. Processes of S1 to S3 described below are performed for each of a plurality of the rotation speeds when the vibration is measured.

First, to calculate a vibration amplitude with respect to a frequency, Fourier transformation is performed on time series vibration acceleration data of each of a plurality of rotation speeds obtained in the measuring step (S1: analyzing step).

Subsequently, an angular velocity is calculated from the rotation speed, and the vibration amplitude is divided by a square of the angular velocity (S2). Since it is proven that an excitation force due to a bearing failure is proportionate to approximately a square of a rotation speed, vibration amplitude data in which the influence of the rotation speed is removed can be obtained through the process of S2.

Subsequently, the vibration amplitude data is converted from a frequency domain to a ratio frequency domain (S3). A ratio frequency is a value obtained by dividing a frequency by a rotational frequency. The process of S3 allows equivalently handling vibration accelerations measured at any rotation speeds.

Subsequently, whether or not the processes of S1 to S3 have been completed for all the rotation speeds is determined (S4). After the process of at S4 has been completed, mean values of the vibration amplitude data obtained at all the rotation speeds are calculated for the respective ratio frequencies, and combined (S5). By performing the processes of S1 to S5, the influence of a magnitude of transfer function can be removed, and a random noise without periodicity can be reduced. S2 to S5 constitute an example of a vibration mean value calculating step of the disclosure.

After the vibration accelerations at the plurality of rotation speeds are combined into one, as the mean value of the vibration amplitude data obtained at all the rotation speeds which are calculated for the respective ratio frequencies, an amplitude due to the failure of the bearing 7 is extracted (S6: bearing-caused vibration value extracting step). Vibration generation frequencies corresponding to portions of the bearing 7, such as an inner race, an outer race, and a rolling body, can be calculated from design specifications of the bearing 7. Formula 1, Formula 2, and Formula 3 indicate calculation formulas of the ratio frequency at which the vibration is generated at the inner race, the outer race, and the rolling body, respectively. Here, fᵢ is a generation frequency of the inner race vibration, fₒ is a generation frequency of the outer race vibration, f_{b} is a generation frequency of the rolling body vibration, fᵣ is a rotational frequency, Z is the number of the rolling bodies of the bearing 7, D is a pitch circle diameter of the bearing 7, d is a rolling body diameter of the bearing 7, α is a contact angle of the bearing 7, and N is the order. The calculation of N is as described below.

$${f}_{i} / {f}_{r} = [ \frac{z}{2} ( 1 + \frac{d}{D} cos α ) \pm 1 ] N \qquad ( 1 )$$

$${f}_{o} / {f}_{r} = [ \frac{z}{2} ( 1 - \frac{d}{D} cos α ) ] N \qquad ( 2 )$$

$${f}_{b} / {f}_{r} = \frac{D}{d} [ 1 - {( \frac{d}{D} )}^{2} {( cos α )}^{2} \pm 0.45 ] N \qquad ( 3 )$$

The amplitudes of the vibration at the ratio frequencies corresponding to the portions of the bearing 7 are extracted in S6. Then, the amplitude of the extracted N-order component (bearing-caused vibration value) is compared with a predetermined threshold to diagnose the state of the bearing 7 (S7: failure determining step). In this embodiment, the state of the bearing 7 is diagnosed as abnormal when the maximum value of bearing-caused vibration value at all the portions of the bearing 7 exceeds the threshold. Further, in the determination of whether or not the bearing 7 is abnormal, the maximum value of the bearing-caused vibration value of each portions of the bearing 7 may be compared with a predetermined threshold for each portions of the bearing 7. Furthermore, the maximum value of the bearing-caused vibration value of each N-order components may be compared with a predetermined threshold for each N-order components. In addition, a combination thereof may be used.

When the bearing state is diagnosed to be abnormal, whether or not the amplitude of the N-order component has an outstanding value is determined for each bearing portion (S8). When a failure cause includes two characteristic ratio frequencies, such as an inner race scratch and a rolling body scratch, for an order, the values of the vibration amplitude are aggregated into one value for each order. The aggregation method is preferably averaging or taking the smaller value.

When the amplitude of the N-order component has an outstanding value, namely, when the certain bearing-caused vibration value is large, the vibration is caused by a wide scratch, and the failure cause is estimated as a poor lubrication (S9). When the amplitude of the N-order component has no outstanding value, namely, when it is not that the certain bearing-caused vibration value is large, the vibration is caused by a spot scratch, and the failure cause is estimated as an overload or a contamination with foreign matter (S10). S8 to S10 constitute an example of a failure occurrence cause estimating step of the disclosure.

Next, a method for determining whether or not the amplitude of the N-order component has an outstanding value will be described.

For a largest vibration amplitude and a second largest vibration amplitude in the vibration amplitude of the N-order component, when a value obtained by dividing the largest vibration amplitude by the second largest vibration amplitude is equal to or more than a predetermined threshold (for example, 1.5), it can be determined that an outstanding vibration amplitude is present.

Coefficients are compared between an approximation formula of the vibration amplitudes of the N-order components from which an order to be determined is excluded and an approximation formula of the vibration amplitudes of the N-order components from which the order to be determined is not excluded, and when the difference is larger than a predetermined threshold, it may be determined that an outstanding vibration amplitude is present.

Further, the estimation of the failure cause will be described below with reference to a specific example.

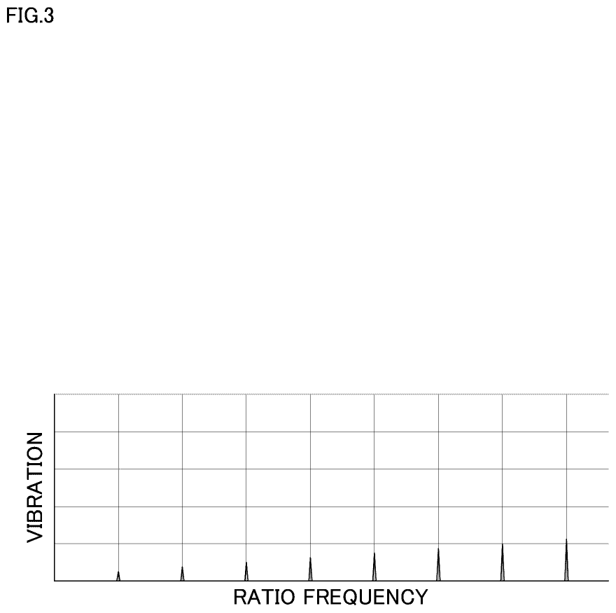

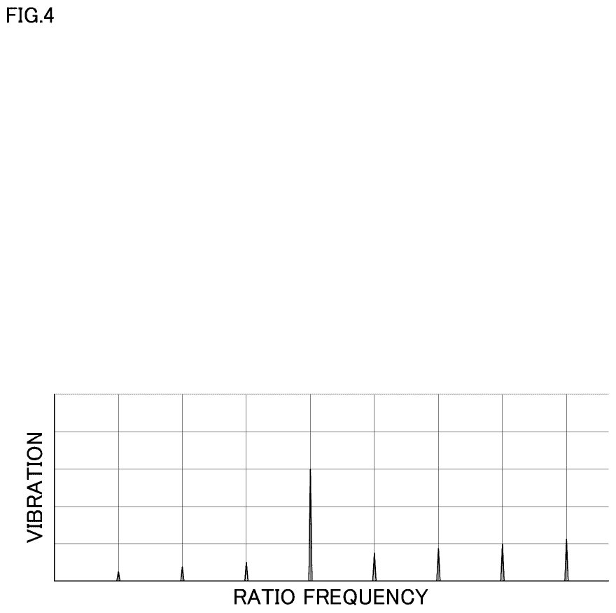

A minimum value Nₘᵢₙ and a maximum value Nₘₐₓ of a measurable N-order component are determined based on an effective frequency band based on the specification of the vibration sensor 8 and the generation frequency of the vibration corresponding to the portion of the bearing 7. The generation frequency of the vibration corresponding to the portion of the bearing 7 is determined by the design of the bearing 7 and the measured rotation speed condition under which the measuring step is performed. Here, if the effective frequency band of the vibration sensor 8 is 10 to 5000 Hz, and the generation frequency of the vibration corresponding to the portion of the bearing 7 is 600×N (Hz) at the maximum rotation speed and 100×N (Hz) at the minimum rotation speed among the rotation speeds at which the measuring step is performed, the N-order component (maximum value Nₘₐₓ) at The generation frequency at the maximum rotation speed in the effective frequency band is calculated as 5000/600≈8. Further, the N-order component (minimum value Nₘᵢₙ) in the generation frequency at the minimum rotation speed in the effective frequency band is calculated as 10/100≈1. Then, under the above conditions, it is assumed that it is diagnosed in S7 that the outer race of the bearing 7 has an abnormality, namely, an outer race scratch has occurred. In FIG. 3, among the amplitudes of the N-order components of N=1 to 8, a value obtained by dividing the vibration amplitude of the first largest 8th order component by the vibration amplitude of the second largest 7th order component is smaller than 1.5 which is the threshold value. Therefore, it is determined that an outstanding value is not found in the amplitude of the N-order component of N=1 to 8. Accordingly, the outer race scratch is a spot scratch, and the failure cause is estimated as an overload or a contamination with foreign matter. On the other hand, in FIG. 4, among the amplitudes of the N-order components of N=1 to 8, the value obtained by dividing the vibration amplitude of the first largest 4th component by the vibration amplitude of the second largest 8th component is larger than 1.5 which is the threshold value. Therefore, it is determined that the amplitude of the fourth order component is outstanding among the amplitude of the N-th order component of N=1 to 8. Accordingly, the outer race scratch is a wide scratch, and the failure cause is estimated as a poor lubrication.

In the method and the device for estimating the cause of the bearing failure in the above-described configuration, the vibration when the main spindle 1 (an example of a rotator) is rotated at a constant velocity is measured at a plurality of rotation speeds, and the magnitude of the vibration with respect to the frequency is calculated from the vibration obtained through the measurement by the frequency analysis (S1). Subsequently, the influence of the rotation speed is removed, and the mean value of the magnitudes of the vibrations having the same ratio of the frequency with respect to the rotational frequency is calculated from the result of the frequency analysis at the plurality of rotation speeds obtained by the frequency analysis, thus calculating the vibration mean value (S2 to S5). Subsequently, the bearing-caused vibration value at the characteristic ratio frequency, which is an integer multiplied ratio of the frequency at which the vibration is caused by the bearing 7 with respect to the rotational frequency, is extracted from the vibration mean values (S6), and whether or not the bearing 7 is abnormal is determined based on the bearing-caused vibration value (S7).

Then, when the bearing 7 is determined to be abnormal, the failure occurrence cause is estimated based on the relation of the bearing-caused vibration values in the integer multiplied characteristic ratio frequencies at which the vibrations are caused by the bearing 7 (S8 to S10).

With the configuration, the estimation of the failure cause leading to the change of the bearing state can be performed together with the measurement for the diagnosis of the bearing state.

While the computing unit has a function of the analyzing unit, the vibration mean value calculation unit, the failure determination unit, and the failure occurrence cause estimation unit of the disclosure in the above-described configuration, the respective functional units may be separated.

The disclosure is not limited to those for estimating a cause of a failure of a bearing that supports a main spindle of a machine tool. The disclosure is applicable also to a rotator other than the main spindle.

The disclosure is applicable to mechanical equipment other than the machine tool insofar as the mechanical equipment supports a rotator with a rolling bearing.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A method for estimating a cause of a bearing failure when a failure occurs on a bearing that supports a rotator, the method comprising:
measuring a vibration when the rotator is rotated at a constant velocity at a plurality of rotation speeds;
calculating a magnitude of the vibration with respect to a frequency from the vibration obtained in the measuring by a frequency analysis;
calculating a vibration mean value by removing an influence of the rotation speed and calculating a mean value of the magnitudes of the vibrations having a same ratio of the frequency with respect to a rotational frequency from a result of the frequency analysis at the plurality of rotation speeds obtained in the calculating of the magnitude;
extracting a bearing-caused vibration value of a characteristic ratio frequency from the vibration mean values, the characteristic ratio frequency being an integer multiplied ratio of the frequency at which the vibration is caused by the bearing with respect to the rotational frequency;
determining whether or not the bearing is abnormal based on the bearing-caused vibration value; and
estimating a failure occurrence cause based on a relation of the bearing-caused vibration values in the integer multiplied characteristic ratio frequencies at which the vibrations are caused by the bearing when the bearing is determined to be abnormal in the determining.

2. The method for estimating a cause of a bearing failure according to claim 1, wherein
in the estimating, for the bearing-caused vibration values in the integer multiplied characteristic ratio frequencies at which the vibrations are caused by the bearing:
a failure cause is estimated as a poor lubrication when only the bearing-caused vibration value of one integer multiplied characteristic ratio frequency is large; and
the failure cause is estimated as an overload or a contamination with foreign matter when it is not that only the bearing-caused vibration value of one integer multiplied characteristic ratio frequency is large.

3. A device that estimates a cause of a bearing failure when a failure occurs on a bearing that supports a rotator, the device comprising:
a measuring unit that measures a vibration when the rotator is rotated at a constant velocity at a plurality of rotation speeds;
an analyzing unit that calculates a magnitude of the vibration with respect to a frequency from the vibration obtained by the measuring unit by a frequency analysis;
a vibration mean value calculating unit that calculates a vibration mean value by removing an influence of the rotation speed and calculating a mean value of the magnitudes of the vibrations having a same ratio of the frequency with respect to a rotational frequency from a result of the frequency analysis at the plurality of rotation speeds obtained by the analyzing unit;
a bearing-caused vibration value extracting unit that extracts a bearing-caused vibration value of a characteristic ratio frequency from the vibration mean values, the characteristic ratio frequency being an integer multiplied ratio of the frequency at which the vibration is caused by the bearing with respect to the rotational frequency;
a failure determining unit that determines whether or not the bearing is abnormal based on the bearing-caused vibration value; and
a failure occurrence cause estimating unit that estimates a failure occurrence cause based on a relation of the bearing-caused vibration values in the integer multiplied characteristic ratio frequencies at which the vibrations are caused by the bearing when the bearing is determined to be abnormal by the failure determining unit.

4. The device that estimates a cause of a bearing failure according to claim 3, wherein
in the failure occurrence cause estimating unit, for the bearing-caused vibration values in the integer multiplied characteristic ratio frequencies at which the vibrations are caused by the bearing:
a failure cause is estimated as a poor lubrication when only the bearing-caused vibration value of one integer multiplied characteristic ratio frequency is large; and
the failure cause is estimated as an overload or a contamination with foreign matter when it is not that only the bearing-caused vibration value of one integer multiplied characteristic ratio frequency is large.
